(19) United States
(12) Patent Application Publication
(10) Pub. No.: US 2011/0183559 A1
(43) Pub. Date: Jul. 28, 2011

(54) Method for Recycling Waste Shoe Soles and a Laminate Made According to the Method

(76) Inventor: Michael LIN, Taipei County (TW)

(21) Appl. No.: 12/792,722

(22) Filed: Jun. 2, 2010

(30) Foreign Application Priority Data
Jan. 27, 2010 (TW) 099102250

(51) Int. Cl. C08J 11/00; B32B 7/02; B05D 1/28; B29C 43/28

(52) U.S. Cl. 442/59; 427/428.01; 264/257

(57) ABSTRACT

A method for recycling waste shoe soles includes: (a) disintegrating the waste shoe soles to form a recycled material; (b) heating the recycled material; and (c) laminating the heated recycled material onto a fabric layer to form a laminate. A laminate made according to the method is also disclosed.

### CROSS-REFERENCE TO RELATED APPLICATION

This application claims priority of Taiwanese application no. 099102250, filed on Jan. 27, 2010.

### BACKGROUND OF THE INVENTION

1. Field of the Invention

This invention relates to a method for recycling waste shoe soles and a laminate made according to the method.

2. Description of the Related Art

Presently, shoe soles are commonly made of natural rubber, polyurethane, thermoplastic rubber, polyvinyl chloride, ethylene vinyl acetate, etc. Although methods for recycling waste shoe soles have been proposed, the product from by the recycled waste shoe soles has poor tensile strength and thus, is likely to break and has poor elongation property.

### SUMMARY OF THE INVENTION

Therefore, an object of the present invention is to provide a method for recycling waste shoe soles that can overcome the aforesaid drawbacks associated with the prior art and a laminate made according to the method.

According to one aspect of this invention, a method for recycling waste shoe soles is provided. The method comprises:

(a) disintegrating the waste shoe soles to form a recycled material;

(b) heating the recycled material; and

(c) laminating the heated recycled material onto a fabric layer to form a laminate.

According to another aspect of this invention, a laminate of the present invention is provided. The laminate comprises a layer of a recycled material obtained from waste shoe soles, and a fabric layer reinforcing and supporting the recycled material. The laminate is produced by:

(a) disintegrating the waste shoe soles to form a recycled material;

(b) heating the recycled material; and

(c) laminating the heated recycled material onto a fabric layer.

### BRIEF DESCRIPTION OF THE DRAWING

Other features and advantages of the present invention will become apparent in the following detailed description of the preferred embodiments of the invention, with reference to the accompanying drawing, in which:

FIG. 1 is a flowchart showing a preferred embodiment of the method for recycling waste shoe soles according to the present invention.

### DETAILED DESCRIPTION OF THE PREFERRED EMBODIMENTS

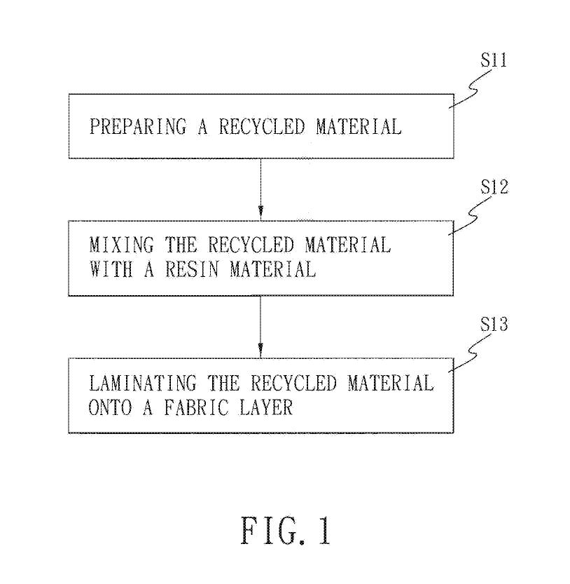

Referring to FIG. 1, a method for recycling waste shoe soles according to the preferred embodiment is shown.

In step S11, a recycled material is prepared by obtaining waste shoe soles, wet-sterilizing and cleaning the waste shoe soles, disintegrating the shoe soles, followed by size-fractioning the disintegrated sole particles. The waste shoe soles can be midsoles or outsoles of waste shoes, the material of which can be natural rubber, polyurethane, thermoplastic rubber, polyvinyl chloride, ethylene vinyl acetate, etc. Furthermore, the waste shoe soles may be disintegrated by cutting and grinding the shoe soles.

For increasing a flowability of the recycled material and for efficiently mixing the shoe sole particles; additives are preferably added to the recycled material such that the shoe sole particles in the recycled material have a concentration ranging from 50 wt % to 95 wt %. The additives may be those usually added in a raw material of shoe soles, such as a lubricant (a processing aid), a crosslinking agent, an activator, and so on.

In step S12, the recycled material is mixed with a resin material. In this embodiment, the resin material is natural rubber, and in other embodiments, the resin material can be synthetic resin, such as polyurethane, thermoplastic rubber, polyvinyl chloride, ethylene vinyl acetate, etc.

In step S13, the recycled material and the resin material are heated to a temperature that is above 180° C. to be laminated on a fabric layer to form a laminate. Specifically, in this embodiment, the laminate is formed by spreading the recycled material onto a fabric layer that is advanced on a conveyor, laminating the recycled material onto the fabric layer by hot rolling that is conducted at the temperature above 180° C., followed by cooling. Preferably, during lamination, the recycled material may be cleaned and deodorized by purging contaminants with a gas at a temperature above 180° C. The fabric layer in this embodiment is composed of non-woven fabric. In other embodiments, the fabric layer maybe composed of warp-and-weft fabric, and the recycled material may be laminated onto the fabric layer by compression molding.

According to the above method of this invention, the resultant laminate includes a layer of a recycled material obtained from waste shoe soles, and the fabric layer reinforcing and supporting the recycled material. Preferably, the fabric layer has a tensile strength of above 20 pounds per square inch, and the layer of the recycled material has a thickness ranging from 0.4 mm to 2.5 mm. Because the layer of the recycled material is laminated on the fabric layer with relatively high tensile strength, the laminate of the present invention can be provided with better elongation and is not likely to break. Accordingly, the laminate of the present invention has relatively good quality due to improved tensile strength and thus, is suitable to be formed as a raincoat, a wind breaker, a bag, etc.

Furthermore, in an alternative embodiment, in the step of laminating the recycled material onto the fabric layer, instead of spreading the recycled material onto the fabric layer, the recycled material is heat pressed to form the layer of the recycled material, followed by laminating the layer of the recycled material to the fabric layer.

While the present invention has been described in connection with what are considered the most practical and preferred embodiments, it is understood that this invention is not limited to the disclosed embodiments but is intended to cover various arrangements included within the spirit and scope of the broadest interpretations and equivalent arrangements.

What is claimed is:

1. A method for recycling waste shoe soles, comprising:
(a) disintegrating the waste shoe soles to form a recycled material;
(b) heating the recycled material; and
(c) laminating the heated recycled material onto a fabric layer to form a laminate.

2. The method of claim 1, wherein the step (c) is conducted by hot rolling or by compression molding.

3. The method of claim 1, wherein said fabric layer is made of a material selected from the group consisting of non-woven fabric and warp-and-weft fabric.

4. The method of claim 1, further comprising mixing the recycled material with a resin material.

5. The method of claim 1, wherein the step (b) is conducted at a temperature that is above 180° C.

6. A laminate comprising a layer of a recycled material obtained from waste shoe soles, and a fabric layer reinforcing and supporting the recycled material, the laminate being produced by:
(a) disintegrating the waste shoe soles to form a recycled material;
(b) heating the recycled material; and
(c) laminating the heated recycled material onto a fabric layer.

7. The laminate of claim 6, wherein the fabric layer has a tensile strength of above 20 pounds per square inch.

8. The laminate of claim 6, wherein the layer of the recycled material has a thickness ranging from 0.4 mm to 2.5 mm.
